(19) United States
(12) Patent Application Publication
(10) Pub. No.: US 2014/0065312 A1
(43) Pub. Date: Mar. 6, 2014

(54) INLINE RESIN-INFUSED FIBER PLACEMENT SYSTEMS AND METHODS

(71) Applicants: Stephen Bertram Johnson, Greenville, SC (US); William Arthur Flodder, Greenville, SC (US)

(72) Inventors: Stephen Bertram Johnson, Greenville, SC (US); William Arthur Flodder, Greenville, SC (US)

(73) Assignee: General Electric Company

(21) Appl. No.: 13/599,115

(22) Filed: Aug. 30, 2012

(51) Int. Cl. B05C 13/00; B05D 3/00

(52) U.S. Cl. 427/385.5; 118/500; 118/696

(57) ABSTRACT

Inline resin-infused fiber placement systems include a resin impregnation assembly that infuses a resin into one or more fiber tows to form one or more inline resin-infused fiber tows and one or more stationary fiber placement heads that place the inline resin-infused fiber tows onto a movable placement surface, wherein the moveable placement surface moves relative to the one or more stationary fiber placement heads while it receives the inline resin-infused fiber tows from the one or more stationary fiber placement heads.

### BACKGROUND OF THE INVENTION

The subject matter disclosed herein relates to fiber placement systems and methods and, more specifically, to inline resin-infused fiber placement systems and methods.

Resin-infused fiber materials are being used increasingly in a variety of diverse industries such as automotive, aircraft, and wind energy, in part because of their high strength and stiffness to weight ratios. These resin-infused fiber materials can form complex composite components and/or fiber patterns for a variety of applications. The manufacturing processes for such components can involve the use of dry fiber pre-forms with subsequent resin infusion, or placement of preimpregnated fiber tows called “prepregs.” However, dry pre-forms can be very labor intensive to prepare, and prepreg tows may require significant capital. One possible alternative to these methods includes the inline combination of fiber tows and resin such that the two materials are mixed and infused to produce inline resin-infused fiber tows. These inline resin-infused fiber tows may then be laid out onto a work surface to produce one or more carbon strips that can be used for various manufacturing applications.

Nonetheless, manufacturing inline resin-infused fiber tows can involve using expensive and cumbersome robotic or gantry style fiber placement technology in which the one or more fiber placement heads travel along the surface of mold while placing the inline resin-infused fiber tows. These systems can also require that subsequent finishing steps (e.g., cooling, curing, cutting, coating, etc.) occur in the same location as the original placement. This can delay the subsequent placement of the next batch of inline resin-infused fiber tows until the manufacturing of first batch is complete.

Accordingly, alternative inline resin-infused fiber placement systems and methods would be welcome in the art.

### BRIEF DESCRIPTION OF THE INVENTION

In one embodiment, an inline resin-infused fiber placement system is disclosed. The inline resin-infused fiber placement system includes a resin impregnation assembly that infuses a resin into one or more fiber tows to form one or more inline resin-infused fiber tows, and one or more stationary fiber placement heads that place the inline resin-infused fiber tows onto a movable placement surface. The moveable placement surface moves relative to the one or more stationary fiber placement heads while it receives the inline resin-infused fiber tows from the one or more stationary fiber placement heads.

In another embodiment, an inline resin-infused fiber placement method is disclosed. The inline resin-infused fiber placement method includes combining a resin with one or more fiber tows to form one or more inline resin-infused fiber tows and placing the one or more inline resin-infused fiber tows from one or more stationary fiber placement heads onto a moveable placement surface that moves relative to the one or more stationary fiber placement heads.

In yet another embodiment, a method of manufacturing a blade component is disclosed. The method includes combining a resin with one or more fiber tows to form one or more inline resin-infused fiber tows and placing the one or more inline resin-infused fiber tows from one or more stationary fiber placement heads onto a moveable placement surface that moves relative to the one or more stationary fiber placement heads, wherein the inline resin-infused fiber tows form a blade component configuration on the moveable placement surface.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 illustrates a side view of an inline resin-infused fiber placement system according to one or more embodiments shown or described herein;

FIG. 2 illustrates a top view of the inline resin-infused fiber placement system of FIG. 1 according to one or more embodiments shown or described herein;

FIG. 3 illustrates a front view of a moveable placement surface and moveable placement surface guide according to one or more embodiments shown or described herein;

FIG. 4 illustrates a top view of the moveable placement surface and moveable placement surface guide of FIG. 3 according to one or more embodiments shown or described herein;

FIG. 5 illustrates a side view of another inline resin-infused fiber placement system according to one or more embodiments shown or described herein;

FIG. 6 illustrates a front view of a moveable placement surface according to one or more embodiments shown or described herein;

FIG. 7 illustrates a front view of another moveable placement surface 30 comprising a contoured base surface according to one or more embodiments shown or described herein;

FIG. 8 illustrates a front view of a transfer system according to one or more embodiments shown or described herein;

FIG. 9 illustrates a side view of a transfer system according to one or more embodiments shown or described herein; and

FIG. 10 illustrates an inline resin-infused fiber placement method according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Fiber placement systems may generally comprise a resin impregnation assembly and one or more stationary fiber placement heads that combine to apply and infuse resin into fiber tows. The one or more stationary fiber placement heads can then place the inline resin-infused fiber tows onto a moveable placement surface that moves relative to the one or more stationary fiber placement heads while receiving the inline resin-infused fiber tows. By moving the movable placement surface itself, as opposed to the one or more stationary fiber placement heads, the inline fiber placement system may become more efficient and economical. Inline resin-infused fiber placement systems and methods will be discussed in more detail herein.

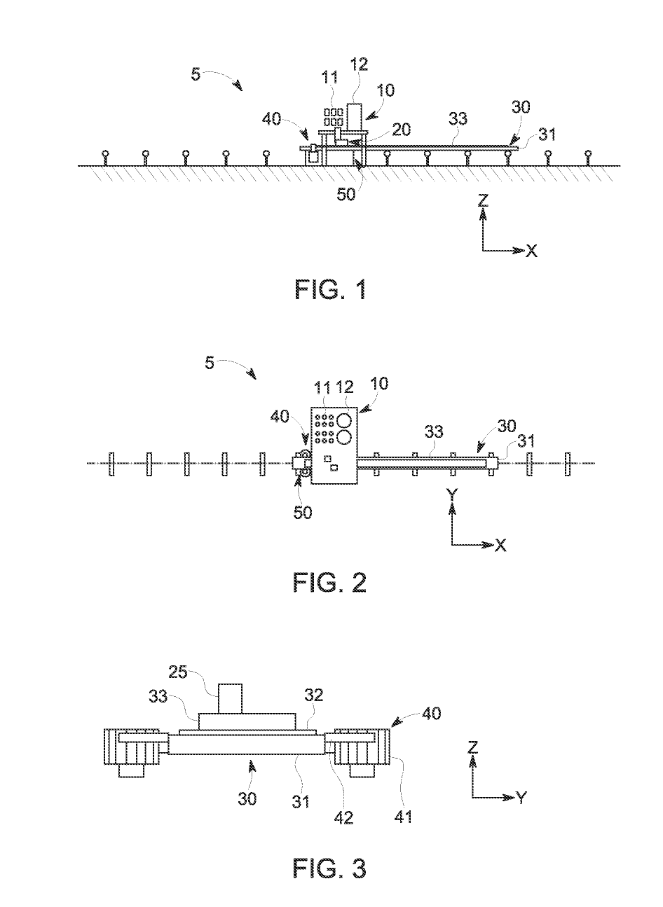

Referring now to FIGS. 1 and 2, an inline resin-infused fiber placement system 5 is illustrated. The inline resin-infused fiber placement system 5 generally comprises a resin impregnation assembly 10, one or more stationary fiber placement heads 20 and a moveable placement surface 30. The resin impregnation assembly 10 comprises an assembly that applies and infuses a resin to one or more fiber tows.

As used herein, the term “fiber tow” refers to any member of the general class of filaments, fibers, tows comprising multiple (for example, 10,000-50,000) fibers, and fiber tapes. Typically, the strength of the interleaved structure is reduced when the tows contain more than 50,000 fibers, while manufacturing costs increase when the tows contain fewer than 3000 fibers. In two examples, 12,000 and 24,000 fiber tows were used. Non-limiting examples of fiber types include glass fibers, high strength fibers (such as carbon fibers), harder shear resistant fibers (such as metallic or ceramic fibers), and high toughness fibers (such as S-glass, aramid fibers, and oriented polyethylene fibers). Non-limiting examples of aramid fibers include Kevlar® and Twaron®. Kevlar® is sold by E. I. du Pont de Nemours and Company, Richmond Va. Twaron® aramid fibers are sold by Tejin Twaron, the Netherlands. Non-limiting examples of oriented polyethylene fibers include Spectra® and Dyneema®. Spectra® fiber is sold by Honeywell Specialty Materials, Morris N.J. Dyneema® fiber is sold by Dutch State Mines (DSM), the Netherlands.

In some embodiments, the resin impregnation assembly 10 may comprise one or more carbon creels 11 and one or more resin tanks 12. The carbon creels 11 can store the fiber tows prior to the application and infusion of the resin to form the one or more inline resin-infused fiber tows. For example, in some embodiments the one or more carbon creels 11 can comprise multiple spools. In such embodiments, each of the fiber tows can be initially wound on a respective one of the spools. In even some embodiments, one or more spool tensioners may be provided to control the tension of the fiber tows on the carbon creel 11.

The one or more resin tanks 12 can store the resin that is to be applied and infused into the one or more fiber tanks. The resin can include, for example, thermosetting polymeric resins, such as vinyl ester resin, polyester resins, acrylic resins, epoxy resins, polyurethane resins, and combinations thereof.

Still referring to FIGS. 1 and 2, the inline resin-infused fiber placement system 5 further comprises the one or more stationary fiber placement heads 20. The one or more stationary fiber placement heads 20 receive the one or more inline resin-infused fiber tows from the resin impregnation assembly 10 and place the one or more inline resin-infused fiber tows onto the movable placement surface 30. In some embodiments, the one or more stationary fiber placement heads 20 may comprise a variety of components to facilitate the receiving, cooling, directing, cutting and/or other necessary steps in placing the inline resin-infused fiber tows 25 onto the placement surface such as those disclosed in commonly assigned U.S. patent application Ser. No. 12/621,623, which is hereby incorporated by reference in its entirety. For example, the one or more stationary fiber placement heads 20 may comprise a cooler for cooling the inline resin-infused fiber tows 25, a cutter assembly for cutting the inline resin-infused fiber tows 25, and/or a compaction assembly to receive and compact the inline resin-infused fiber tows 25. While specific components of the one or more stationary fiber placement heads 20 have been disclosed herein, it should be appreciated that any other additional or alternative components may also be realized such that the one or more fiber placement heads 20 can receive inline resin-infused fiber tows 25 and place them on the movable placement surface 30.

The one or more stationary fiber placement heads 20 are fixed in place such that they do not move vertically or laterally during operation. In some embodiments, the resin impregnation assembly 10 may also be fixed in place along with the one or more stationary fiber placement heads 20. By fixing the one or more stationary fiber placement heads 20 in place, the various components of the resin impregnation assembly 10, such as the carbon creels 11 and/or the resin tanks 12, may be refilled or replaced at a consistent location.

Still referring to FIGS. 1 and 2, the inline resin-infused fiber placement system 5 further comprises a moveable placement surface 30. The moveable placement surface 30 moves relative to the one or more stationary fiber placement heads 20 while receiving the inline resin-infused fiber tows 25 from the one or more stationary fiber replacement heads 20. The moveable placement surface 30 may be moved by any variety of systems such that its movement can be controlled relative to the one or more stationary fiber placement heads 20 during operation.

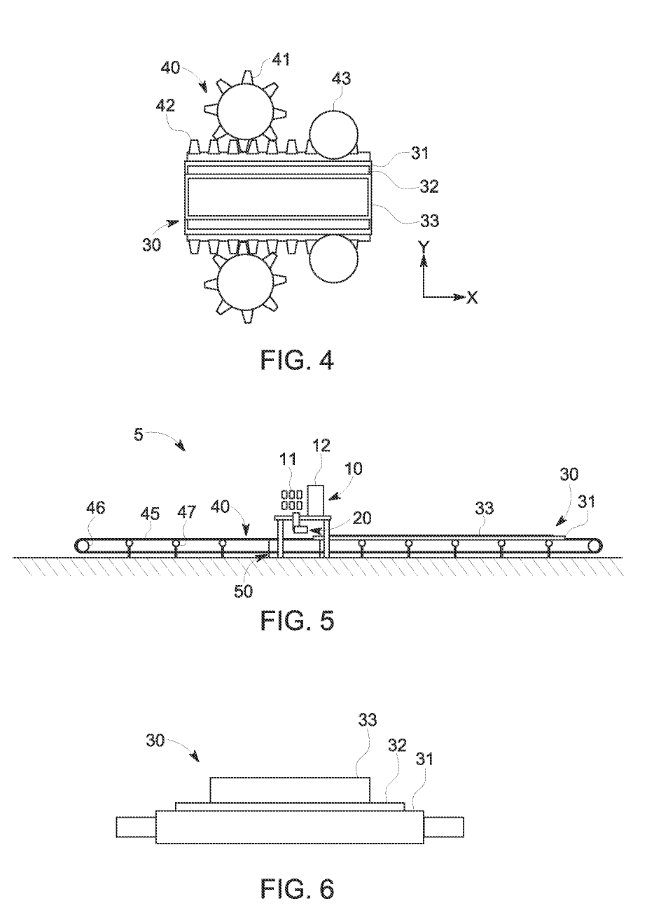

For example, in some embodiments the moveable placement surface 30 may be controlled by a moveable placement surface guide 40. The moveable placement surface guide 40 can comprise any type of system that can move the moveable placement surface 30 in the lateral x, longitudinal y and/or vertical z directions. For example, in some embodiments, such as that illustrated in FIGS. 1-4, the moveable placement surface guide 40 may comprise a rack and pinion design. Specifically, the moveable placement surface guide 40 may comprise one or more pinions 41 that cooperate with one or more racks 42. The moveable placement surface 30 may rest on top of the one or more racks 42 such that as the one or more pinions 41 rotate to move the one or more racks 42, the moveable placement surface 30 also moves accordingly. Depending on the set-up of the one or more pinions and the one or more racks 42, the moveable placement surface 30 may thereby move in at least the lateral direction x relative to the one or more stationary fiber placement heads 20. Moreover, in some embodiments, the moveable placement surface guide 40 may further comprise one or more guide rollers 43 that can guide the moveable placement surface 30 while it is on the one or more racks 42. This can help ensure that the carbon strip 33 (formed from the already placed inline resin-infused fiber tows 25) remains in proper position relative to the one or more stationary fiber placement heads 20 during operation.

Referring now to FIG. 5, in some embodiments the moveable placement surface guide 40 may comprise a cable drive system. For example, the moveable placement surface guide 40 can comprise a drive cable 46 wrapped around one or more drive drums 46. A plurality of support rollers 47 may also be incorporated to support the drive cable 45 and it extends between the one or more drive drums 46. In such embodiments, the moveable placement surface 30 may rest on top of the drive cable 45 such that as the one or more drive drums 46 rotate to move the drive cable 45, the moveable placement surface 30 also moves accordingly.

In even other embodiments, the moveable placement surface guide 40 may comprise any other type of system that can move the moveable placement surface 30 in the lateral x, longitudinal y, vertical z, and/or rotational directions. For example the moveable placement surface guide 40 can comprise any combination of rollers, conveyors, lifts, motors (e.g., linear stepper motors) or other elements that facilitate movement such that the moveable placement surface 30 may be moved thereon either automatically or manually during operation.

As best illustrated in FIGS. 1 and 5, in some embodiments the movement of the moveable placement surface 30 on the moveable placement surface guide 40 may be automatically controlled by a moveable placement surface positioning system 50. The moveable placement surface positioning system 50 can comprise any system that automatically controls the movement of the moveable placement surface guide 40 to dictate the lateral x, longitudinal y and/or vertical z movement of the moveable placement surface 30 relative to the one or more stationary fiber placement heads 20. For example, the moveable placement surface positioning system 50 can comprise any computer based controller such as a computer numerical control (“CNC”) based machine. However, the moveable placement surface positioning system 50 may alternatively or additionally comprise any other operable system to automatically control the movement of the moveable placement surface guide 40.

Referring now to FIGS. 1-2 and 6-7, the moveable placement surface 30 can comprise any variety of materials and components that allow for it to move relative to the one or more stationary fiber placement heads 20 while receiving the inline resin-infused fiber tows to form, for example, a carbon strip 33.

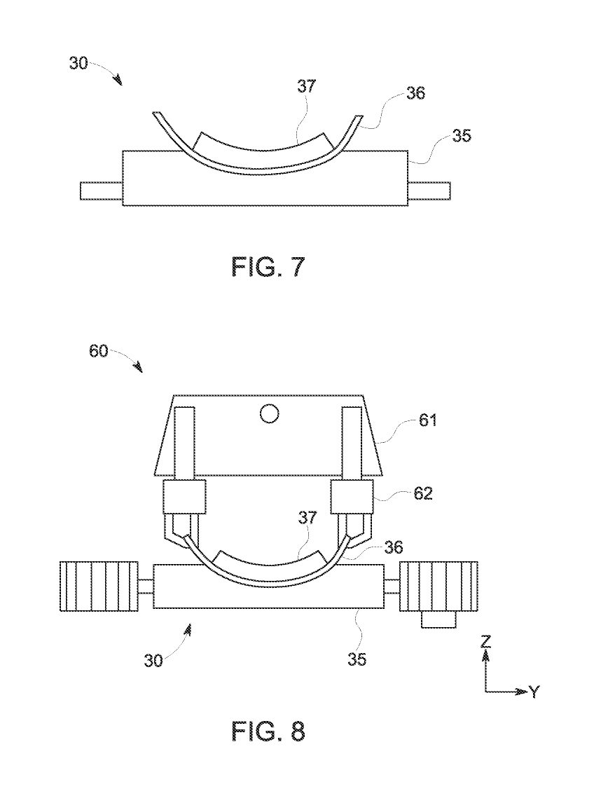

For example, as best illustrated in FIGS. 6 and 7, in some embodiments the moveable placement surface 30 may comprise a base surface 31 and a transfer media 32. The carbon strip 33 (or any other product formed from the resin-infused fiber tows 25) may thus be placed onto the transfer media 32 while the moveable placement surface moves in any direction relative to the one or more stationary fiber placement heads 20. The transfer media 32 can comprise any material that is releasably disposed on the base surface 31 and can receive the carbon strip 33. In some embodiments, where the transfer media 32 is not present, the inline resin-infused fiber tows 25 may be placed directly onto the base surface 31. In even some embodiments, the carbon strip may be placed onto some other surface that is stacked on top of, or integral with, the base surface 31 or the transfer media 32.

The moveable placement surface 30 and its components may comprise any material or materials that facilitate the placement and transferring of the carbon strip 33. For example, in some embodiments the base layer may comprise any material that can physically support the carbon strip 33 and retain a mold profile as will become appreciated herein. In some embodiments, when a transfer media 32 is present, the transfer media may comprise any flexible and/or releasable material that can support the carbon strip 33 when it is transferred away from the moveable placement surface 30 as will also become appreciated herein. For example, in some embodiments the base surface 31 and/or the transfer media 32 may comprise reusable material that can be used in a plurality of operations.

As best illustrated in FIG. 6, in some embodiments the moveable placement surface 30 may comprise a relatively flat profile. Specifically, the base surface 31 and the transfer media 32 may both comprise flat profiles such that the carbon strip 33 applied thereon also forms a substantially flat profile. However, as best illustrated in FIG. 7, in some embodiments, the moveable placement surface 30 may comprise a contoured profile. Specifically, moveable placement surface 30 may comprise a contoured base surface 35 and/or a contoured transfer media 36 such that it receives and forms a contoured carbon strip 37. The contoured profile may comprise any geometric or non-geometric profile such as a substantially curved profile as illustrated. In such embodiments, the curved contoured carbon strip 37 that is produced as a result of the contoured base surface 35 and the contoured transfer media 36 may be utilized in a variety of aerodynamic support structures such as spar caps, blades, blade molds or any other alternative use. Furthermore, in some embodiments the contoured profile may comprise other variations such as rotational twists about the lateral x, longitudinal y, or vertical z directions, and or positional shifts the lateral x, longitudinal y, or vertical z directions.

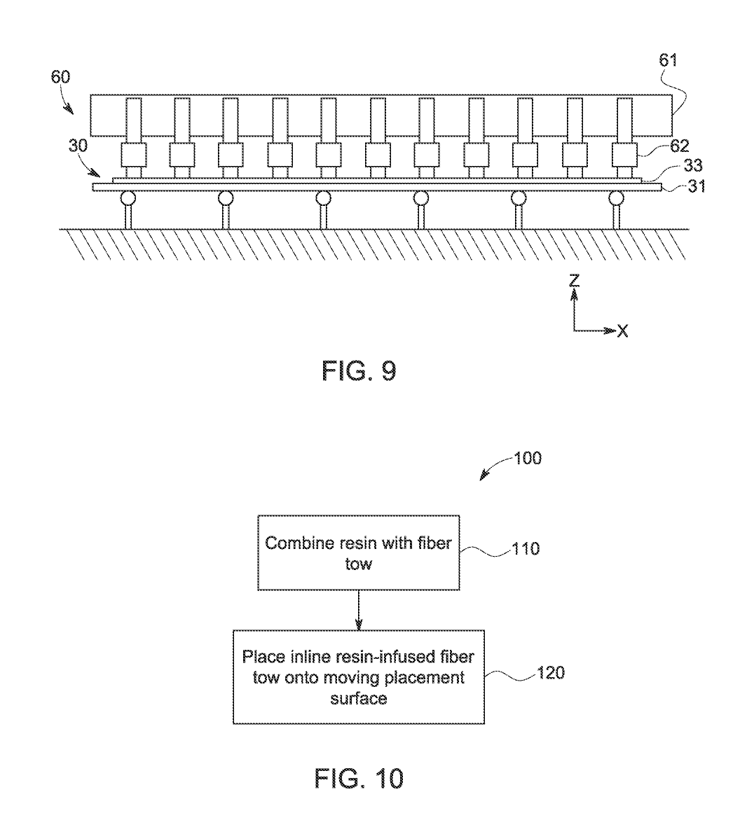

Referring now to FIGS. 8 and 9, in some embodiments the inline resin-infused fiber placement system 5 may further comprise a transfer system 60 to transfer the carbon strip 33 from the moveable placement surface 30 to another location, such as a curing and/or assembly station. Specifically, the carbon strip 33 can be transferred away from the moveable placement surface 30 for any further processing or delivery such as additional curing, coating, shaping, cutting or other manufacturing steps. In some embodiments, after the carbon strip 33 is completed on the moveable placement surface 30, the carbon strip 33 may be transferred away from the inline resin-infused fiber placement system 5 via the transfer system 60 so that the first carbon strip 33 can be cured (or otherwise processed) while the inline resin-infused fiber placement system 5 places a new carbon strip 33 on the moveable placement surface 30. This can free up the inline resin-infused fiber placement system 5 to continue production of carbon strips 33 by freeing up the moveable placement surface 30 during subsequent processing.

The transfer system 60 can comprise any variety of transfer systems that can pick up or otherwise move the carbon strip 33 away from the moveable placement surface 30. For example, in some embodiments the transfer system 60 may comprise one or more grips 62 connected to a lifting beam 61. The one or more grips 62 can comprise any type of apparatus that can either lift the contoured carbon strip 33 directly, or lift any other intermediary layer that the carbon strip 33 rests on such as the contoured transfer media 36. In some embodiments, such as that illustrated in FIGS. 8 and 9, the transfer system 60 can comprise a plurality of grips that extend along the lateral direction x such that the carbon strip 33 and/or transfer media 32 may be picked up at multiple locations along the lateral direction x. While the transfer system 60 illustrated in FIGS. 8 and 9 comprises a plurality of grips, it should be appreciated that a variety of other transfer mechanisms may alternatively or additionally be incorporated such as pneumatic arms, lifts, clamps or any other suitable device.

Referring now to FIG. 10, an inline resin-infused fiber placement method 100 is illustrated for manufacturing one or more inline resin-infused fiber tows such as by using the inline resin-infused fiber placement system 5 discussed above. With reference to the inline resin-infused fiber placement method 100 illustrated in FIG. 10, as well as the inline resin-infused fiber placement system 5 illustrated in FIGS. 1 and 2, the inline resin-infused fiber placement method 100 first comprises combining a resin with one or more fiber tows in step 110 to produce one or more inline resin-infused fiber tows 25. As discussed above, the resin can initially be stored in one or more resin tanks 12 and the fiber tows can initially be stored in one or more carbon creels 11 as part of the resin impregnation assembly 10 of the fiber placement system. The resin and fiber tows may further be combined in any suitable mechanism to form either a single or a plurality of inline resin-infused fiber tows 25.

After the resin is combined with the fiber two in step 110 to form one or more inline resin-infused fiber tows 25, the one or more inline resin-infused fiber tows 25 are placed from one or more stationary fiber placement heads 20 onto a moveable placement surface 30 to form a carbon strip 33. By only moving the moveable placement surface 30 relative to the one or more stationary fiber placement heads 20, the fiber placement system may provide for its larger or more cumbersome components to remain stationary while still producing a carbon strip 33. As discussed above, the moveable placement surface 30 can be moved by any variety moveable placement surface guides 40 and moveable placement surface positioning systems 50, comprise any variety of materials, and potentially comprise additional transfer systems 60.

In some embodiments, the inline resin-infused fiber placement system may be utilized for a method of manufacturing a blade component. The blade component can include any individual component that makes up a blade. Blades can include various types of rotor blades such as those used for wind turbines. Blade components can thereby include such wind turbine rotor blade components as spar caps, shear webs, shells, or individual sections thereof. In such embodiments, the method can include combining a resin with one or more fiber tows to form one or more resin-infused fiber tows 25 as discussed above. The method can further comprise placing the one or more inline resin-infused fiber tows 25 from one or more stationary fiber placement heads 20 onto a moveable placement surface 30 that moves relative to the one or more stationary fiber placements heads 20. Specifically, the inline resin-infused fiber tows 25 can be placed to form a blade component configuration on the moveable placement surface 30.

The blade component configuration can comprise any shape defined by the blade component such as the shape of a spar cap, shear web, shell or the like. In some embodiments, the blade component configuration may comprise a curved cross section such as potentially present in a spar cap. In even some embodiments, the blade component configuration can comprise a bend in a longitudinal direction y as the moveable placement surface moves in a lateral direction x. Such configurations may be present for example when the blade component comprises a curved blade.

It should now be appreciated that inline resin-infused fiber placement systems and inline resin-infused fiber placement methods can provide for the manufacturing of carbon strips using inline resin-infused fiber tows without the need for expensive and/or cumbersome robotic or gantry style fiber placement heads. Specifically, by using one or more stationary fiber placement heads in combination with a moveable placement surface, the inline resin-infused fiber tows may be manufactured using one or more stationary fiber placement heads and even potentially a stationary resin impregnation assembly. Not only can these systems and methods reduce or eliminate the high capital machinery required to move the fiber placement heads, but these systems and methods also free up the placement surface for new batches while previous batches undergo subsequent manufacturing processes. The resulting resin-infused fiber materials can be used for a variety applications including, but not limited to, wind energy (e.g., spar caps, blades, molds, etc.), aircraft, automotive and the like.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An inline resin-infused fiber placement system comprising:
a resin impregnation assembly that infuses a resin into one or more fiber tows to form one or more inline resin-infused fiber tows; and,
one or more stationary fiber placement heads that place the inline resin-infused fiber tows onto a movable placement surface, wherein the moveable placement surface moves relative to the one or more stationary fiber placement heads while it receives the inline resin-infused fiber tows from the one or more stationary fiber placement heads.

2. The inline resin-infused fiber placement system of claim 1 further comprising a moveable placement surface guide that moves the moveable placement surface relative to the one or more stationary fiber placement heads.

3. The inline resin-infused fiber placement system of claim 2, wherein the moveable placement surface guide comprises a rack and pinion guide.

4. The inline resin-infused fiber placement system of claim 2, wherein the moveable placement surface guide comprises a drive belt guide.

5. The inline resin-infused fiber placement system of claim 2 further comprising a moveable placement surface positioning system that automatically controls the position of the moveable placement surface guide.

6. The inline resin-infused fiber placement system of claim 5, wherein the moveable placement surface positioning system comprises a computer numerical control based machine.

7. The inline resin-infused fiber placement system of claim 1, wherein the moveable placement surface comprises a transfer media releasably disposed on top of a base surface.

8. The inline resin-infused fiber placement system of claim 7, wherein the base surface comprises a contoured base surface.

9. The inline resin-infused fiber placement system of claim 8, wherein the transfer media comprises a contoured transfer media that conforms to the contoured base surface.

10. The inline resin-infused fiber placement system of claim 1, wherein the resin impregnation assembly comprises at least one carbon creel and at least one resin tank.

11. The inline resin-infused fiber placement system of claim 1, wherein the inline resin-infused fiber tows placed onto the movable placement surface form a spar cap.

12. The inline resin-infused fiber placement system of claim 1 further comprising a transfer mechanism to transfer the inline resin-infused fiber tows away from the moveable placement surface.

13. An inline resin-infused fiber placement method comprising:
combining a resin with one or more fiber tows to form one or more inline resin-infused fiber tows; and,
placing the one or more inline resin-infused fiber tows from one or more stationary fiber placement heads onto a moveable placement surface that moves relative to the one or more stationary fiber placement heads.

14. The inline resin-infused fiber placement method of claim 13 further comprising transferring the inline resin-infused fiber tows away from the moveable placement surface.

15. The inline resin-infused fiber placement method of claim 14 further comprising curing the inline resin-infused fiber tows after they have been transferred away from the moveable placement surface.

16. The inline resin-infused fiber placement method of claim 15 further comprising placing a new batch of one or more inline resin-infused fiber tows from the one or more stationary fiber placement heads onto the moveable placement surface while curing the transferred inline resin-infused fiber tows.

17. A method of manufacturing a blade component, the method comprising:
combining a resin with one or more fiber tows to form one or more inline resin-infused fiber tows; and,
placing the one or more inline resin-infused fiber tows from one or more stationary fiber placement heads onto a moveable placement surface that moves relative to the one or more stationary fiber placement heads, wherein the inline resin-infused fiber tows form a blade component configuration on the moveable placement surface.

18. The method of claim 17, wherein the blade component comprises a spar cap.

19. The method of claim 18, wherein the blade component configuration comprises a curved cross section.

20. The method of claim 18, wherein the blade component configuration comprises a bend in a longitudinal direction as the moveable placement surface moves in a lateral direction perpendicular to the longitudinal direction.
